(19) United States
(12) Patent Application Publication
(10) Pub. No.: US 2026/0270274 A1
(43) Pub. Date: Sep. 10, 2026

(54) Multi-Agent Artificial Intelligence System and Method for Autonomous Cyber Threat Detection, Analysis, Simulation, and Remediation in Multi-Cloud and Hybrid Cloud Environments with Specialized SAP Ecosystem Integration and Governance

(71) Applicant: Manish Kumar, Cypress (IN)

(72) Inventor: Manish Kumar, Cypress, TX (US)

(21) Appl. No.: 19/532,916

(22) Filed: Feb. 6, 2026

(51) Int. Cl. H04L 9/40

(52) U.S. Cl. CPC H04L 63/1416; H04L 63/105

(57) ABSTRACT

A decentralized multi-agent artificial intelligence system autonomously orchestrates cyber threat management in multi-cloud and hybrid cloud environments, featuring specialized integration for SAP ecosystems including S/4HANA, SAP Business Technology Platform, and SAP HANA. The system comprises agents for monitoring, SAP-specific analysis, threat simulation, remediation, and coordination that employ multi-agent reinforcement learning (MARL) for consensus-driven decisions and adaptive responses. The system ingests SAP telemetry including audit logs and GRC alerts, simulates ERP exploits using generative AI, and executes tailored remediations including RFC isolation while maintaining privacy via federated learning and confidential computing. A governance module treats agents as non-human identities with bounded autonomy, reducing mean time to remediation and false positive rates.

### CROSS-REFERENCE TO RELATED APPLICATIONS

This application is related to U.S. patent application Ser. No. 19/457,302, filed Jan. 23, 2026, titled “System and Method for Federated AI-Driven Control and Optimization in Hybrid Cloud Environments,” by the same inventor, which describes federated AI techniques applicable to hybrid cloud environments. The present invention extends such concepts into the domain of autonomous multi-agent cybersecurity with specialized integration for SAP ecosystems. The entire disclosure of the above-identified application is incorporated herein by reference.

### STATEMENT REGARDING FEDERALLY SPONSORED RESEARCH OR DEVELOPMENT

Not applicable. This invention was not made with government support under any federally sponsored research or development program.

### PRIOR ART REFERENCES

### U.S. Patent Documents

U.S. Pat. No. 9,009,837 B2, issued Apr. 14, 2015 to Onapsis S. R. L., “Automated Security Assessment of Business-Critical Systems and Applications.”
U.S. Pat. No. 12,111,859 B2, issued Oct. 8, 2024 to C3.ai, Inc., “Enterprise Generative Artificial Intelligence Architecture.”
U.S. Pat. No. 11,625,314, issued Apr. 11, 2023 to TestCraft Technologies Ltd., “Training an Agentic AI System to Interact with Software Applications.”

### International Patent Publications

International Publication No. WO 2025/024326 A2, published Jan. 30, 2025, “Generative AI Workflow Systems for Enterprise Automation.”

### Non-Patent Literature

Tellache, A. et al., “MARL-based Intrusion Detection Systems,” Cryptography and Security, arXiv preprint arXiv: 2407.05766, July 2024.
George, J., “Multi-Agent Reinforcement Learning for Coordinated Cyber Defense in Edge AI Networks,” ResearchGate, 2025.
Gjini, A., Daci, G., and Aranitasi, M., “Securing the Cloud with AI: How Multi-Agent Systems Detect and Prevent Cyber Threats,” in AI and Digital Transformation (ICITTBT 2025), Communications in Computer and Information Science, vol. 2669, Springer, 2026.
Vinay, V., “The Evolution of Agentic AI in Cybersecurity: From Single LLM Reasoners to Multi-Agent Systems and Autonomous Pipelines,” arXiv preprint arXiv: 2512.06659, December 2025.
Fujitsu Limited, “Multi-AI Agent Technology for Automated Vulnerability Simulation,” Press Release, December 2024.
Ethan, A. and Noah, N., “Multi-Agent AI Systems for Securing Cloud-Edge Workflows,” ResearchGate, April 2025.
Cloud Security Alliance (CSA), “Framework for Multi-Agent AI Governance in Cloud Security,” 2025.
CyberArk, “2026 Cybersecurity Predictions: AI Agents as Non-Human Identities,” December 2025.
Palo Alto Networks, “6 Predictions for the AI Economy: 2026's New Rules of Cybersecurity,” November 2025.
Google Cloud, “2026 Cybersecurity Forecast: Agentic AI in Security Operations,” 2026.
McMahan, B. et al., “Communication-Efficient Learning of Deep Networks from Decentralized Data,” Proceedings of the 20th International Conference on Artificial Intelligence and Statistics (AISTATS), PMLR 54:1273-1282, 2017.
Onapsis Research Labs, “SAP Security Patch Day Analysis,” 2024-2026 Reports.

### FIELD OF THE INVENTION

This invention pertains to the fields of artificial intelligence, cybersecurity, cloud computing, and enterprise resource planning (ERP) systems. More particularly, the invention relates to multi-agent agentic artificial intelligence systems and methods for autonomous threat lifecycle management in distributed multi-cloud environments with ERP-specific protections, including specialized integration with SAP ecosystems such as S/4HANA, SAP Business Technology Platform (BTP), and SAP HANA.

### BACKGROUND OF THE INVENTION

Multi-cloud and hybrid cloud adoption has increased significantly across enterprises, with organizations managing critical business data and processes across Amazon Web Services (AWS), Microsoft Azure, Google Cloud Platform, and on-premises infrastructure. Enterprises operating SAP systems handle particularly sensitive data including financial records, human resources information, supply chain data, and business process configurations that are critical to operational continuity.

Cybersecurity threats targeting SAP systems have escalated in both frequency and sophistication. These threats include, but are not limited to, authorization escalations via transaction codes such as SU01 and PFCG, ABAP code injection attacks, exploitation of Remote Function Call (RFC) connections, manipulation of financial modules (FI/CO), and unauthorized access to SAP HANA database layers. Reports from 2024-2026 SAP Security Patch Day disclosures and analyses by security firms such as Onapsis have documented the growing attack surface of SAP ecosystems in cloud-deployed environments.

Existing cybersecurity solutions include single-model artificial intelligence detectors such as Microsoft Sentinel, which provide cloud-native security information and event management (SIEM) capabilities, and static SAP vulnerability scanners. U.S. Pat. No. 9,009,837 B2 to Onapsis describes automated assessment systems for business-critical applications, including SAP vulnerability scanning and compliance auditing. However, these solutions operate as isolated point tools and lack the ability to perform autonomous, collaborative remediation across multiple cloud providers simultaneously.

Recent patent literature (2023-2026) covers aspects of multi-agent AI systems in general contexts. U.S. Pat. No. 12,111,859 B2 to C3 AI describes enterprise generative AI architecture with multi-agent orchestration using multimodal models and iterative orchestrator-agent interactions. U.S. Pat. No. 11,625,314 teaches training agentic AI systems to interact with software applications through historical session log processing. International Publication No. WO 2025/024326 A2 discloses generative AI workflow systems for enterprise automation.

Academic and industry research has addressed multi-agent approaches to cybersecurity. Tellache et al. (arXiv: 2407.05766, July 2024) describe MARL-based intrusion detection systems but focus on network-layer detection without ERP integration or cross-cloud remediation. George (2025) describes multi-agent reinforcement learning for coordinated cyber defense in edge AI networks but does not address SAP-specific threats or enterprise governance requirements. Gjini et al. (ICITTBT 2025/Springer 2026) review multi-agent systems for cloud security through a literature survey without presenting a specific integrated architecture. Vinay (arXiv: 2512.06659, December 2025) presents a five-generation taxonomy of agentic AI in cybersecurity from single LLM reasoners to multi-agent systems, identifying multi-agent coordination and response validation as unresolved challenges. Fujitsu has disclosed multi-AI agent technology (December 2024) for vulnerability simulation. Ethan and Noah (April 2025) have explored multi-agent AI systems for securing cloud-edge workflows.

Industry trends in 2025-2026 emphasize agentic AI deployment in Security Operations Centers (SOCs). Google Cloud's 2026 cybersecurity forecast identifies autonomous AI agents as essential for SOC modernization. Palo Alto Networks' 2026 predictions describe a surge in AI agent attacks and the need for autonomous defense systems. The Cloud Security Alliance (CSA) has published frameworks for multi-agent governance. CyberArk's 2026 predictions identify the treatment of AI agents as non-human identities (NHIs) as an emerging security paradigm, noting that machine identities outnumber human employees by 82:1 in typical enterprises.

Federated learning for privacy-preserving cybersecurity has also received significant attention. McMahan et al. (AISTATS 2017) introduced the FedAvg algorithm for communication-efficient decentralized learning. Recent work has applied federated learning to intrusion detection systems in IoT and SDN environments. However, no known application of federated learning addresses the specific challenge of training threat detection models on distributed SAP telemetry across multi-cloud deployments while preserving data residency requirements.

### Distinction Over Prior Art

The following table summarizes the key distinctions between the present invention and the closest prior art references:

| | Onapsis (U.S. Pat. No. | C3 AI (U.S. Pat. No. | |
|---|---|---|---|
| Feature | 9,009,837) | 12,111,859) | Present Invention |
| SAP-Specific | SAP scanning only; no | General-purpose agents; no | Dedicated SAP Specialist Agent |
| Agent | autonomous agents | SAP specialization | with SM20, GRC, SU01, HANA |
| | | | interfaces |
| MARL | Not taught | Orchestrator-directed; no | Q-learning based multi-agent |
| Consensus | | RL-based consensus | consensus with reward |
| | | | optimization |
| Cross-Cloud | Single-system | Multi-data-source retrieval; | Automated remediation across |
| Remediation | assessment | no remediation execution | AWS, Azure, GCP, and on- |
| | | | premises SAP |
| Federated | Not taught | Not taught | Privacy-preserving model training |
| Learning | | | with confidential computing |
| | | | enclaves |
| Agent-as-NHI | Not taught | Not taught | Full NHI lifecycle: RBAC, |
| Governance | | | bounded autonomy, risk-tier |
| | | | escalation, audit logging |
| Attack | Static vulnerability | Query decomposition; no | Generative AI-based attack path |
| Simulation | assessment | attack modeling | simulation across SAP business |
| | | | processes |

Despite these advances in the field, no prior art teaches a decentralized multi-agent system incorporating a SAP-specific specialized agent that employs multi-agent reinforcement learning (MARL) for consensus-based, autonomous threat remediation across multi-cloud environments, integrated with federated learning for privacy preservation and a governance framework treating agents as non-human identities. This gap leaves enterprises requiring significant human intervention and experiencing extended mean time to remediation (MTTR) in complex ERP deployment scenarios.

### SUMMARY OF THE INVENTION

The present invention provides a multi-agent artificial intelligence system that deploys specialized, autonomous AI agents across multiple cloud providers for comprehensive cyber threat lifecycle management. The system includes the following novel features and components:

SAP Specialist Agent: A dedicated agent configured for ERP-specific threat detection, including identification of anomalous changes via SAP transaction codes (e.g., SU01 authorization modifications), detection of segregation of duties violations through SAP GRC integration, and monitoring of SAP HANA database access patterns.

Generative AI Attack Simulation: An analysis and simulation agent that utilizes generative artificial intelligence models to construct and evaluate potential attack propagation paths within SAP business processes, including financial module (FI/CO) fraud scenarios, supply chain manipulation, and lateral movement from compromised HANA instances to business process layers.

MARL-Based Coordination: A decentralized coordination mechanism employing multi-agent reinforcement learning (MARL) with Q-learning variants for adaptive consensus-building among heterogeneous agents, enabling optimized collective decision-making that balances threat mitigation effectiveness against operational disruption costs.

Automated Cross-Cloud Remediation: A remediation engine configured to execute coordinated actions across cloud provider APIs and SAP-specific interfaces, including RFC connection isolation, SAP identity management policy enforcement, cloud firewall rule modifications, and GRC policy activation, all operating within bounded autonomy constraints.

Agent Identity Governance: A governance framework that treats each AI agent as a non-human identity (NHI) with role-based access controls (RBAC), comprehensive audit logging, bounded autonomy protocols, and escalation paths to human operators for decisions exceeding predefined risk thresholds.

Federated Learning Integration: Privacy-preserving model training enabling agents to train on distributed SAP data without centralizing sensitive information, with gradient aggregation performed within confidential computing enclaves.

In simulated evaluations and based on 2026 industry benchmarks, the system is designed to achieve mean time to remediation (MTTR) reductions estimated at 50-70% compared to conventional approaches, enhanced horizontal scalability across cloud providers, and maintained compliance with regulatory frameworks including the General Data Protection Regulation (GDPR) and the Sarbanes-Oxley Act (SOX).

### BRIEF DESCRIPTION OF THE DRAWINGS

The accompanying drawings, which are incorporated in and form a part of this specification, illustrate embodiments of the invention and, together with the detailed description, serve to explain the principles of the invention.

FIG. 1 is a system architecture diagram illustrating the overall multi-agent AI system deployed across a multi-cloud environment with SAP ecosystem integration (Sheet 1 of 6).

FIG. 2 is a block diagram illustrating the specialized agent types, their respective roles, and the inter-agent communication protocol (Sheet 2 of 6).

FIG. 3 is a flowchart depicting the autonomous threat detection and response process, including SAP-specific remediation pathways (Sheet 3 of 6).

FIG. 4 is a block diagram illustrating the multi-agent reinforcement learning (MARL) algorithm for agent consensus building and reward optimization (Sheet 4 of 6).

FIG. 5 is a diagram illustrating the federated learning module for privacy-preserving model updates across distributed cloud nodes (Sheet 5 of 6).

FIG. 6 is a layered diagram illustrating the governance framework for agent identity management and autonomy boundaries (Sheet 6 of 6).

### DETAILED DESCRIPTION OF THE EMBODIMENTS

The following detailed description sets forth specific embodiments of the invention. These embodiments are illustrative and are not intended to limit the scope of the invention, which is defined by the appended claims. Those skilled in the art will appreciate that various modifications and equivalent arrangements may be made without departing from the spirit and scope of the invention.

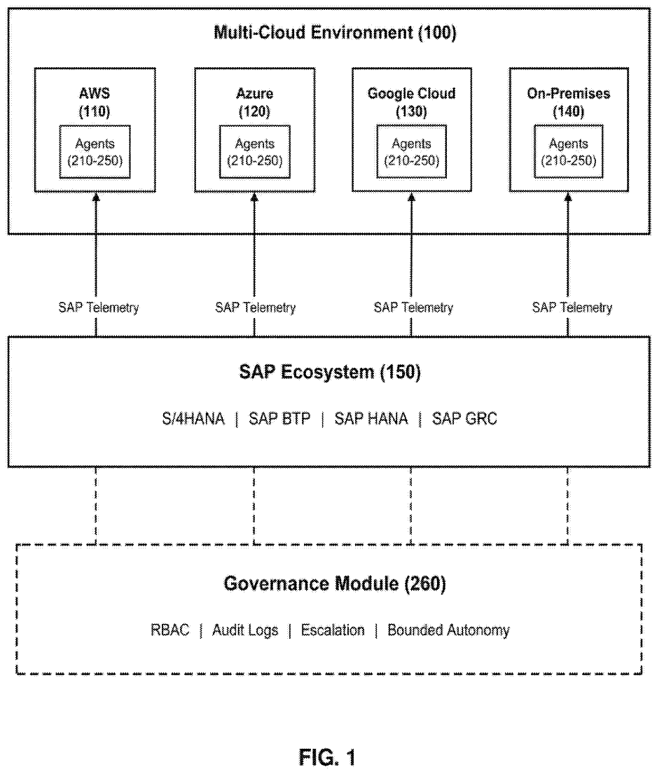

### System Architecture (Reference: FIG. 1)

Referring now to the drawings, and particularly to FIG. 1, the multi-agent AI system (100) is deployed on distributed computing resources across multiple cloud environments. In the exemplary embodiment, the system utilizes containerized microservices deployed on Kubernetes clusters, including but not limited to AWS Elastic Kubernetes Service (EKS), Azure Kubernetes Service (AKS), and Google Kubernetes Engine (GKE). The system spans a multi-cloud environment comprising AWS (110), Azure (120), Google Cloud Platform (130), and on-premises infrastructure (140).

An SAP Ecosystem integration layer (150) connects to all cloud environments via secure telemetry ingestion channels, processing SAP audit logs, security events, GRC alerts, and business process monitoring data. The integration layer supports both push-based event streaming via SAP Cloud Connector and pull-based periodic polling of SAP monitoring views at configurable intervals (e.g., 30-second default polling for SM20 logs, 5-minute intervals for GRC alert aggregation). The Governance Module (260) oversees all system operations through policy enforcement and audit mechanisms.

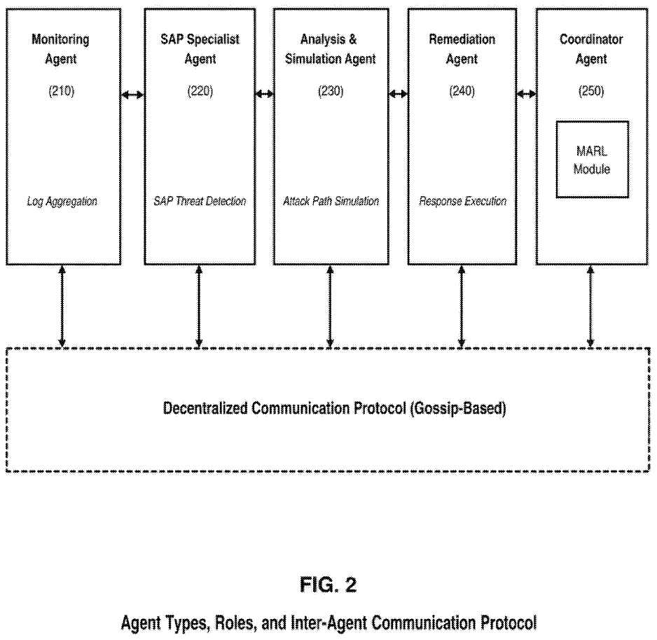

### Agent Components (Reference: FIG. 2)

Monitoring Agent (210): The Monitoring Agent is responsible for aggregating logs and telemetry from heterogeneous cloud sources. In the exemplary embodiment, the agent ingests data from AWS CloudTrail, Azure Activity Logs, Google Cloud Audit Logs, and on-premises syslog sources. The agent performs initial anomaly detection using statistical baseline models including rolling z-score calculations over sliding windows (e.g., 15-minute windows with 3-sigma thresholds) and forwards flagged events to the SAP Specialist Agent and Analysis Agent for further evaluation.

SAP Specialist Agent (220): The SAP Specialist Agent interfaces with SAP application programming interfaces including SM20 security audit logs, GRAC_SOD (Segregation of Duties) alerts from SAP GRC, SU01 user administration logs, ST22 runtime error logs, SM21 system logs, and SAP HANA database monitoring views (M_SERVICE_STATISTICS, M_CONNECTIONS). The agent employs machine learning models trained on SAP-specific behavioral patterns to detect threats including, but not limited to: excessive or anomalous authorization assignments (e.g., more than three role changes per user within a 24-hour period), unauthorized transaction code execution, suspicious RFC connection patterns (e.g., connections from previously unseen IP ranges), ABAP code injection attempts through SE38 or SE80, and unauthorized HANA database queries accessing sensitive financial tables.

Analysis and Simulation Agent (230): The Analysis and Simulation Agent employs generative artificial intelligence models, such as fine-tuned large language models with domain-specific SAP security knowledge, to simulate potential attack propagation paths. Given a detected anomaly, the agent models scenarios including: propagation from a compromised SAP HANA instance to business process disruption via unauthorized stored procedure execution; lateral movement from a single compromised user account to financial module manipulation through SoD-violating transaction chains; and exploitation chains combining multiple low-severity vulnerabilities into high-impact attacks. Each simulated path is assigned a composite risk score based on CVSS-aligned severity metrics, asset criticality weights, and estimated blast radius.

Remediation Agent (240): The Remediation Agent executes coordinated response actions across cloud provider APIs and SAP-specific interfaces. Available remediation actions include: isolating SAP RFC connections via cloud firewall rule modifications using provider-specific APIs (AWS Security Groups, Azure NSGs, GCP Firewall Rules); enforcing GRC policies through SAP API calls to GRAC_ACCESS_CONTROL; disabling compromised user accounts via SU01 API with automatic rollback capability; applying emergency security patches via SAP transport mechanisms (STMS); modifying cloud security group configurations; and triggering incident response workflows via integration with enterprise ITSM platforms.

Coordinator Agent (250): The Coordinator Agent implements the multi-agent reinforcement learning (MARL) consensus mechanism. In the exemplary embodiment, the Coordinator employs Q-learning variants where each participating agent maintains an independent Q-table or policy network. The reward function is defined as: R=(threat_mitigated)−(disruption_cost)−(false_positive_penalty), where threat_mitigated quantifies the severity of the neutralized threat on a 0-100 scale derived from CVSS base scores and asset criticality, disruption_cost measures the operational impact of the remediation action based on affected transaction volumes and business process dependencies, and false_positive_penalty accounts for actions taken on incorrectly classified events weighted by the reversibility of those actions. The Coordinator uses a gossip-based decentralized communication protocol to poll agents and aggregate votes for consensus decisions. In the exemplary embodiment, consensus requires agreement from at least three of four agents (75% threshold) for medium-risk actions and unanimous agreement for high-risk actions.

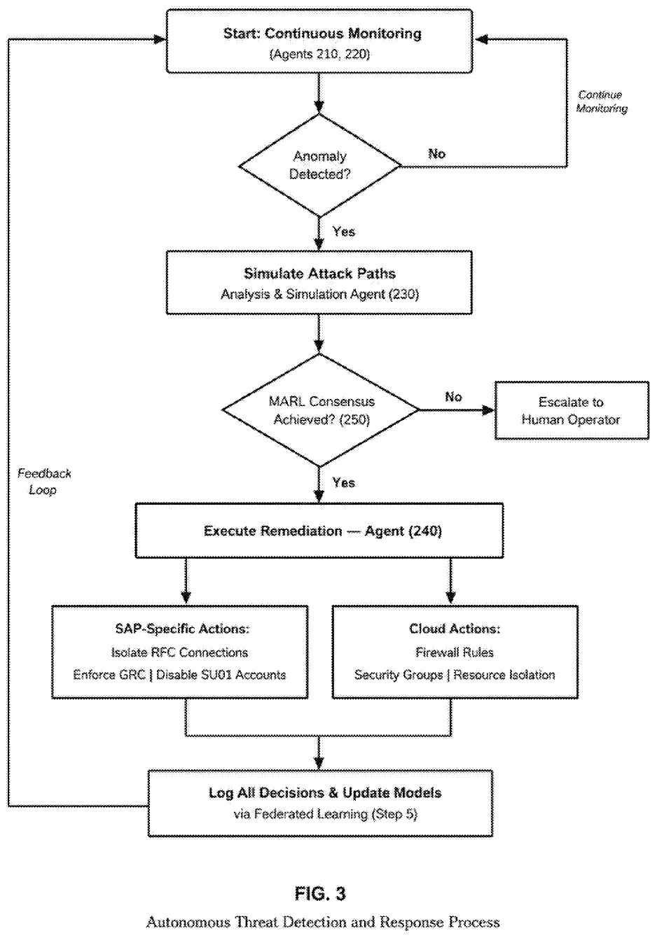

### Operational Workflow (Reference: FIG. 3)

Referring to FIG. 3, the autonomous threat response process operates as follows:

Step 1—Detection: The Monitoring Agent (210) and SAP Specialist Agent (220) continuously monitor cloud resources and SAP instances. Upon detection of an anomaly, such as an unusual financial transaction pattern in the FI module or an unexpected authorization change, the detecting agent generates a threat alert with contextual metadata including timestamp, source system identifier, affected SAP client number, and initial severity classification.

Step 2—Simulation: The Analysis and Simulation Agent (230) receives the threat alert and generates attack path simulations, evaluating potential propagation scenarios and assigning risk scores to each path. In the exemplary embodiment, the agent generates between 3 and 10 candidate attack paths per alert, each evaluated within a timeout window of 30 seconds to maintain responsive operation.

Step 3—Consensus: The Coordinator Agent (250) initiates a consensus round by polling all relevant agents via the decentralized gossip protocol. Each agent evaluates the proposed response actions using its individual Q-table or policy network and submits a vote. The Coordinator aggregates votes using a majority voting mechanism weighted by agent confidence scores. The consensus round operates within a configurable timeout (default: 10 seconds) to ensure timely response.

Step 4—Remediation: Upon achieving consensus, the Remediation Agent (240) executes the selected actions. For SAP-specific threats, this may include isolating RFC connections, enforcing GRC policies, or disabling compromised accounts. For cloud infrastructure threats, actions may include security group modifications or resource isolation. All remediation actions include automated rollback checkpoints enabling reversal within a configurable window (default: 4 hours).

Step 5—Learning and Feedback: All agent decisions and outcomes are logged. The federated learning module processes these logs to update agent models without centralizing raw data. The feedback loop enables continuous improvement of detection accuracy and response optimization. Model updates are propagated via federated averaging at configurable intervals (default: every 100 processed events or 24 hours, whichever occurs first).

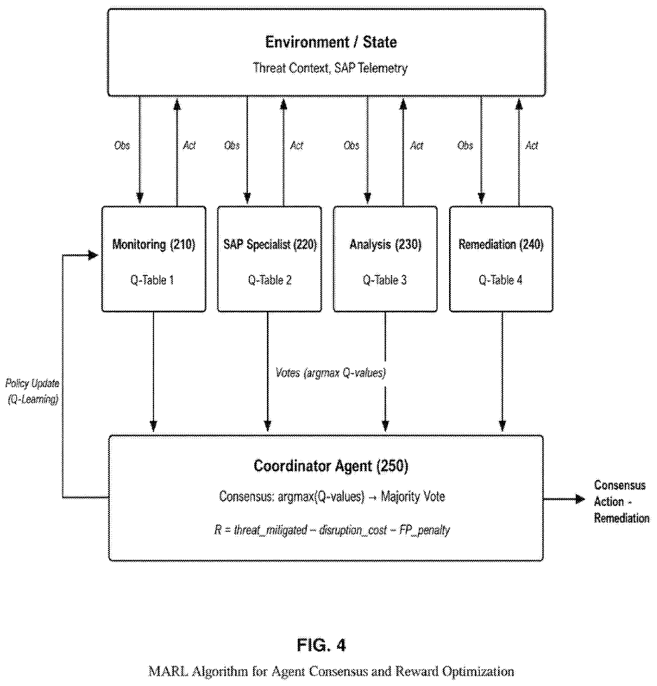

### MARL Algorithm Implementation (Reference: FIG. 4)

Referring to FIG. 4, the MARL coordination algorithm operates in a cycle comprising observation, action selection, reward calculation, and policy update. The following pseudocode illustrates the implementation in the exemplary embodiment:

```
import numpy as np
class MARLCoordinator:
  def _{——}init_{——}(self, num_agents, state_dim, action_dim):
    self.q_tables = [np.zeros((state_dim, action_dim))
```

| | |
|---|---|
| | for _ in range(num_agents)] |
| self.alpha = 0.1 | # Learning rate |
| self.gamma = 0.9 | # Discount factor |
| self.epsilon = 0.1 | # Exploration rate |

```
  def update(self, states, actions, rewards, next_states):
    for i in range(len(self.q_tables)):
      q_predict = self.q_tables[i][states[i], actions[i]]
      q_target = (rewards[i]
```

+ self.gamma
* np.max(self.q_tables[i][next_states[i]]))

```
      self.q_tables[i][states[i], actions[i]] += \
        self.alpha * (q_target − q_predict)
  def consensus_action(self, states):
    votes = [np.argmax(table[state])
          for state, table in zip(states, self.q_tables)]
    return np.argmax(np.bincount(votes))
```

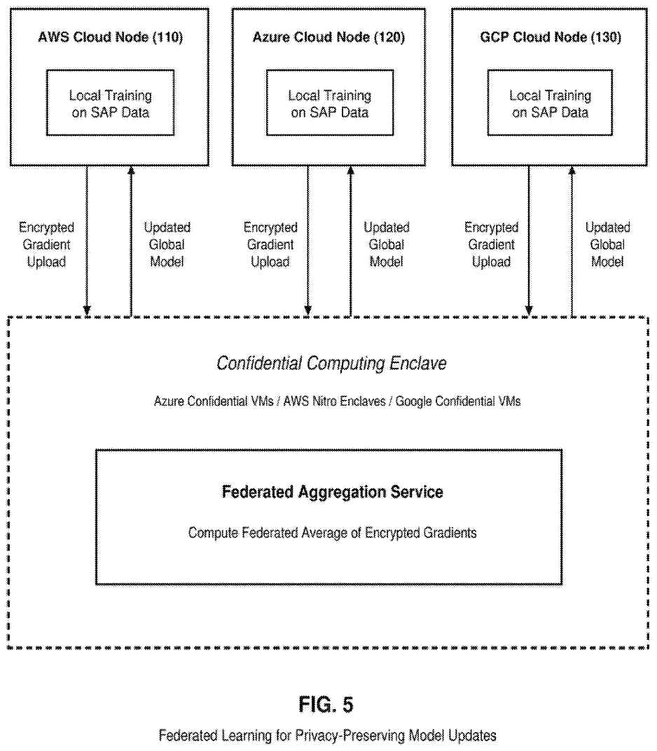

### Federated Learning Module (Reference: FIG. 5)

Referring to FIG. 5, the federated learning module enables each cloud node (110, 120, 130) to perform local model training on SAP telemetry data without transmitting raw data outside its cloud boundary. Model gradient updates are encrypted using TLS 1.3 with AES-256-GCM and transmitted to a central aggregation service operating within a confidential computing enclave, such as Azure Confidential Virtual Machines, AWS Nitro Enclaves, or Google Cloud Confidential VMs with AMD SEV-SNP. The aggregation service computes a federated average of the gradients using the FedAvg algorithm and distributes the updated global model parameters back to all participating nodes.

This architecture ensures compliance with data residency requirements and privacy regulations such as GDPR, as no raw SAP data leaves its originating cloud environment. The confidential computing enclaves provide hardware-level attestation through remote attestation protocols that cryptographically verify the aggregation code has not been tampered with and that gradient data is processed in encrypted memory. Differential privacy noise (with configurable epsilon, default ε=1.0) may optionally be applied to gradient updates before transmission to provide additional privacy guarantees.

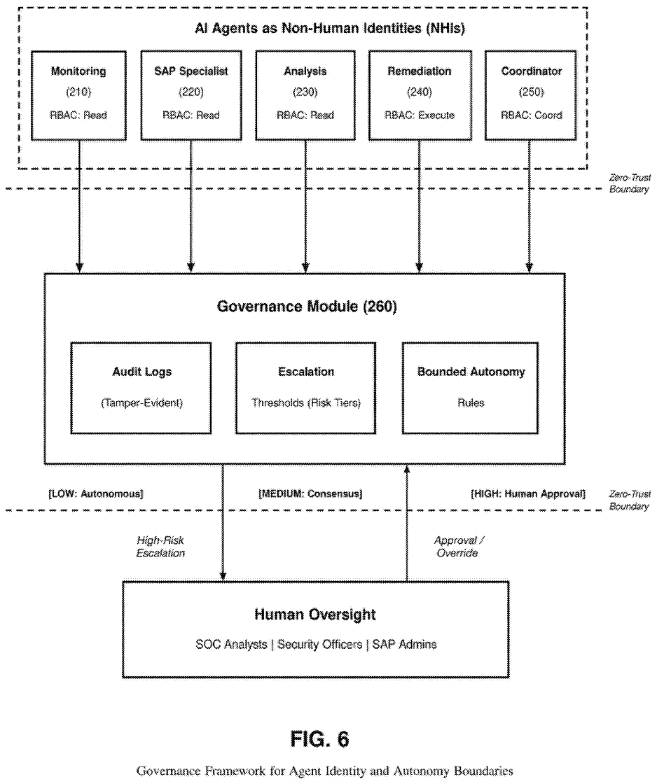

### Governance Framework (Reference: FIG. 6)

Referring to FIG. 6, the Governance Module (260) implements a layered security and accountability framework. Each AI agent (210-250) is treated as a non-human identity (NHI) in accordance with emerging industry standards for AI agent governance. The framework includes:

Role-Based Access Controls (RBAC): Each agent is assigned specific permissions corresponding to its operational role. For example, the SAP Specialist Agent (220) has read access to SAP security logs but cannot directly execute remediation actions without consensus approval. Permissions are defined using a least-privilege model and are cryptographically bound to agent identity certificates with configurable expiration periods.

Audit Logging: All agent decisions, communications, and actions are recorded in tamper-evident audit logs using append-only data structures with cryptographic hash chaining for forensic analysis, compliance reporting, and continuous improvement. Logs are retained for a configurable period (default: 7 years) to satisfy regulatory retention requirements.

Bounded Autonomy Protocols: Each agent operates within predefined autonomy boundaries. Low-risk actions (e.g., generating alerts, updating local models) may be executed autonomously. Medium-risk actions (e.g., isolating non-critical RFC connections) require MARL consensus. High-risk actions (e.g., disabling production SAP user accounts, modifying production firewall rules) require human approval via escalation.

Escalation Thresholds: When a proposed action exceeds predefined risk thresholds based on factors including affected system criticality (production vs. non-production), business process impact (estimated revenue at risk), number of affected users, and reversibility of the action, the Governance Module routes the decision to human operators with full contextual information for manual approval. In the exemplary embodiment, any action affecting more than 50 concurrent users or systems classified as SAP production tier is automatically escalated.

Zero-Trust Boundaries: Inter-agent communications operate on zero-trust principles, with mutual TLS authentication, encrypted channels, and continuous verification of agent identity and authorization status. Each agent-to-agent message includes a digitally signed assertion of the sending agent's current authorization scope.

### ALTERNATIVE EMBODIMENTS

The system architecture is designed for horizontal scalability and extensibility. Alternative embodiments include:

Addition of specialized compliance agents for specific regulatory frameworks, such as a SOX compliance agent for financial reporting controls, a HIPAA agent for healthcare data protection, or a PCI-DSS agent for payment card data environments.

Integration with SAP Joule AI assistant or third-party AI platforms such as Mistral AI or open-source large language models for enhanced natural language processing capabilities in alert summarization and incident reporting.

Deployment using alternative container orchestration platforms or serverless computing architectures such as AWS Lambda, Azure Functions, or Google Cloud Run.

Extension to additional ERP systems beyond SAP, such as Oracle ERP Cloud, Microsoft Dynamics 365, or Workday, through the addition of ERP-specific specialist agents that interface with the respective system APIs.

Substitution of Q-learning with more advanced reinforcement learning algorithms such as Deep Q-Networks (DQN), Proximal Policy Optimization (PPO), or multi-agent actor-critic methods for environments with larger state-action spaces.

### INDUSTRIAL APPLICABILITY

The present invention has direct industrial applicability in enterprise cybersecurity, cloud infrastructure management, and ERP system protection. The multi-agent architecture is particularly suited for organizations operating large-scale SAP deployments across multiple cloud providers, including Fortune 500 enterprises, government agencies, and critical infrastructure operators. The system addresses the documented 4.8 million-person global cybersecurity workforce gap by automating threat detection and response tasks that currently require manual intervention by specialized security analysts. The federated learning architecture enables deployment in regulated industries such as finance, healthcare, and defense where data residency and privacy requirements preclude centralized data aggregation.

What is claimed is:

1. A multi-agent artificial intelligence system (100) for autonomous cyber threat management in multi-cloud environments, comprising: a plurality of specialized AI agents (210, 220, 230, 240, 250) distributed across multiple cloud providers (110, 120, 130), each agent deployed as a containerized microservice on cloud-native orchestration platforms; a SAP-specific agent (220) configured to interface with SAP application programming interfaces to process SAP ecosystem telemetry and detect ERP-specific threats including authorization escalations, unauthorized transaction code executions, and anomalous database access patterns; a decentralized coordination mechanism employing multi-agent reinforcement learning (MARL) with Q-learning based policy optimization for achieving consensus among the plurality of agents on threat response actions; and an automated remediation engine (240) configured to execute cross-cloud and SAP-tailored remediation actions based on the consensus, operating within bounded autonomy constraints defined by a governance module (260).

2. The system of claim 1, wherein the SAP-specific agent (220) interfaces with SAP APIs including SM20 security audit logs, GRAC_SOD segregation of duties alerts from SAP GRC, SU01 user administration logs, and SAP HANA database monitoring views to identify anomalies including authorization escalations, unauthorized ABAP code executions, and suspicious RFC connection patterns.

3. The system of claim 1, further comprising an analysis and simulation agent (230) that utilizes generative artificial intelligence models to construct and evaluate potential attack propagation paths within SAP business processes, including propagation from compromised SAP HANA instances to business process disruption and lateral movement through financial modules.

4. The system of claim 1, wherein the MARL coordination mechanism includes a reward function defined as R=(threat_mitigated)−(disruption_cost)−(false_positive_penalty), wherein threat_mitigated quantifies the severity of a neutralized threat, disruption_cost measures operational impact of remediation actions, and false_positive_penalty accounts for actions taken on incorrectly classified events.

5. The system of claim 1, further incorporating a federated learning module for privacy-preserving model training, wherein each cloud node (110, 120, 130) performs local model training on SAP data and transmits encrypted gradient updates to a central aggregation service for federated averaging without centralizing raw data.

6. The system of claim 5, wherein the central aggregation service for federated learning operates within confidential computing enclaves providing hardware-level attestation to ensure data privacy in multi-tenant cloud environments.

7. The system of claim 1, further comprising a governance module (260) that assigns each AI agent a non-human identity with role-based access controls, maintains tamper-evident audit logs of all agent decisions and actions, and enforces bounded autonomy protocols that categorize actions by risk level.

8. The system of claim 7, wherein the governance module (260) includes escalation paths to human operators for decisions exceeding predefined risk thresholds, the risk thresholds being determined based on affected system criticality, business process impact, and reversibility of proposed actions.

9. The system of claim 1, wherein the automated remediation engine (240) is configured to execute actions including isolating SAP remote function call (RFC) connections via cloud firewall modifications, disabling compromised user accounts via SAP SU01, enforcing SAP GRC policies, and applying emergency security patches via SAP transport mechanisms.

10. The system of claim 1, wherein the system (100) is configured for hybrid cloud deployments including on-premises SAP instances (140) with secure telemetry ingestion from on-premises infrastructure to cloud-deployed agents.

11. A computer-implemented method for autonomous cyber threat remediation in multi-cloud environments with SAP integration, comprising: monitoring cloud resources and SAP instances via a plurality of distributed AI agents (210, 220, 230, 240, 250); detecting threats using a SAP-specific agent (220) that analyzes ERP telemetry including security audit logs, GRC alerts, user administration events, and database access patterns; simulating potential attack propagation paths using a generative AI model (230) that evaluates scenarios within SAP business processes; achieving consensus on response actions among the plurality of agents via multi-agent reinforcement learning using a voting mechanism based on individual agent Q-values; and executing remediation actions tailored to SAP workloads including RFC isolation and GRC policy enforcement while maintaining operational continuity within bounded autonomy constraints.

12. The method of claim 11, further comprising updating agent models via federated learning by performing local training on SAP data at each cloud node and aggregating encrypted gradient updates at a central aggregation service within a confidential computing enclave to preserve data privacy.

13. The method of claim 11, wherein the consensus on response actions is determined by a majority voting mechanism wherein each agent evaluates proposed actions using its independently maintained Q-table and submits a vote weighted by agent confidence scores.

14. The method of claim 11, further comprising governing agent actions by treating each agent as a non-human identity with role-based access controls and performing compliance checks against regulatory requirements including the General Data Protection Regulation (GDPR) and the Sarbanes-Oxley Act (SOX) prior to executing remediation actions.

15. The method of claim 11, wherein the detected threats include SAP-specific vulnerabilities comprising unauthorized ABAP code executions, financial module fraud through FI/CO transaction manipulation, segregation of duties violations, and exploitation of RFC connections for lateral movement.

16. The method of claim 11, further comprising logging all agent decisions, inter-agent communications, consensus proceedings, and remediation actions in tamper-evident audit records for forensic analysis, regulatory compliance reporting, and continuous model improvement.

17. A non-transitory computer-readable medium storing instructions that, when executed by one or more processors, cause the one or more processors to: deploy a plurality of multi-agent AI agents (210, 220, 230, 240, 250) across multiple cloud providers (110, 120, 130) as containerized microservices; process SAP telemetry including security audit logs, GRC alerts, and database monitoring data for threat detection using a SAP-specific agent (220); simulate potential threat propagation paths using a generative AI model (230); coordinate response actions among the plurality of agents via multi-agent reinforcement learning using Q-learning based consensus; execute autonomous remediation actions across cloud providers and SAP interfaces within bounded autonomy constraints; and enforce agent governance by treating each agent as a non-human identity with role-based access controls and audit logging.

18. The non-transitory computer-readable medium of claim 17, wherein the instructions further cause the one or more processors to execute the multi-agent AI agents within confidential computing enclaves providing hardware-level attestation for secure execution in multi-tenant cloud environments.

19. The non-transitory computer-readable medium of claim 17, wherein the instructions further cause the one or more processors to perform federated model aggregation using a federated averaging algorithm for privacy-preserving model optimization, wherein gradient updates are encrypted and aggregated within confidential computing enclaves without centralizing raw SAP data.

20. The non-transitory computer-readable medium of claim 17, wherein the governance instructions limit agent autonomy by categorizing proposed actions into risk tiers and requiring escalation to human operators for actions classified as high-risk based on system criticality and operational impact assessments, thereby preventing unintended disruptions to production SAP environments.
